(19) United States
(12) Patent Application Publication
(10) Pub. No.: US 2023/0047978 A1
(43) Pub. Date: Feb. 16, 2023

(54) System and Method for Real-Time Configuration Analysis

(71) Applicant: Datawire, Inc., Boston, MA (US)

(72) Inventors: Richard D. Li, Needham, MA (US); Alix Cook, Brooklyn, NY (US); Bjorn N. Freeaman-Benson, Portland, OR (US)

(21) Appl. No.: 17/887,542

(22) Filed: Aug. 15, 2022

Related U.S. Application Data
(60) Provisional application No. 63/233,501, filed on Aug. 16, 2021.

(51) Int. Cl. G06F 8/71

(52) U.S. Cl. CPC G06F 8/71

(57) ABSTRACT

A system and method for real-time configuration analysis employs a source code management event listener and a remote server to receive a proposed configuration change event, retrieve a real-time server configuration, determine the effect of a requested change associated with the proposed configuration change event and report an impact of the requested change. In various embodiments, the impact is reported in a user’s interface associated with a source code manager enabling a user to apply the requested change into production if appropriate or seek to resolve a problem as reported before the change is effectuated into production.

### CROSS-REFERENCE TO RELATED APPLICATIONS

The present application claims priority to U.S. Provisional Pat. Application No. 63/233,501 filed on Aug. 16, 2021, entitled “System and Method for Automated Analysis and Resolution of Configuration Changes”, the disclosure of which is incorporated by reference herein in its entirety.

### TECHNICAL FIELD

The present invention relates to software development tools and platforms, particularly for use in cloud computing.

### BACKGROUND AND SUMMARY

As software-as-a-service (SAAS) and cloud computing applications have gained widespread adoption and grown in complexity, traditional monolithic applications have increasingly been broken up into microservices. Monolithic software applications are self-contained, independent computing applications that are responsible for every step or process required to execute given functions. Monolithic software applications can be easy to develop, deploy and scale. However, as a monolithic application grows, it can become unwieldy, and difficult to understand and modify. Microservices offer an alternative software programming option to monolithic applications. With microservices, software developers can build discrete, unassociated, modular code units that perform very specific functions. These code units, or microservices, can be developed and deployed independently, and can generally be easily isolated if a problem occurs. By breaking a large application into microservices, software organizations are able to organize their developers more efficiently.

As an example, e-commerce web sites generally present information about products and services that are available for purchase. For a given product, the information can include the product name, a product image, the product manufacturer, the product’s availability, the product’s price, purchasing options for the product such as size and color, the buyer’s purchasing history for the product, reviews and ratings. In a traditional monolithic architecture, a client such as a desktop or mobile browser would obtain all of the available product information from a single application. This application would encapsulate all the business logic for the ecommerce system.

By contrast, if the e-commerce web site employs microservices, there may be independent microservices performing the required tasks, such as (1) a product information microservice, (2) a product inventory microservice, (3) a product price microservice, (4) a product size option microservice, (5) a product color option microservice, (6) a user history microservice and (7) a product review and rating microservice, for example. A developer or development team in charge of a particular microservice thus has the benefit of being able to focus specifically on the development of that microservice and can generally make adaptations much more easily than if the related functions were tied to a monolithic application. In this architecture, the business logic is broken into smaller components.

In a microservices architecture, each microservice must communicate with one or more other microservices such as via an application programming interface (API). In many cases, an API Gateway is provided in the form of programming that provides all the functionality for a team to independently publish, monitor, and update a microservice.

Traditional API Gateways are managed via REST APIs. Kubernetes™, an open-source system for automating deployment, scaling, and management of containerized applications or microservices, introduced a declarative approach to managing infrastructure. Modern API Gateways have extended Kubernetes™ to adopt a similar approach.

Containerized applications deployed in Kubernetes™ generally follow the microservices design pattern, where an application composed of dozens or even hundreds of microservices communicate with each other. Independent application development teams are responsible for the full lifecycle of a service, including coding, testing, deployment, release, and operations. By giving these teams independence, microservices enable organizations to scale their development without sacrificing agility.

Exemplary configurations according to the present disclosure are built on the concept of policies. A policy is a statement of intent and codified in a declarative configuration file. Embodiments of the present disclosure employ Kubernetes™ Custom Resource Definitions (CRDs) to provide a declarative configuration workflow that is idiomatic with Kubernetes™.

Both operators and application developers can write policies. Typically, operators are responsible for global policies that affect all microservices. Common examples of these types of policies include TLS configuration and metrics. Application development teams want to own the policies that affect their specific service, as these settings can vary from service to service. Examples of these types of service-specific settings include protocols (e.g., HTTP, gRPC, TCP, WebSockets), timeouts, and cross-origin resource sharing settings.

Because many different teams may need to write policies, embodiments of the present disclosure support a decentralized configuration model. Individual policies are written in different files and various embodiments of the present system and method aggregate all policies into one master policy configuration for an edge stack. The edge stack can be considered as a set of proxies that sit between various software applications and end users.

As code cannot provide value to end users until it is running in production, the notion of continuous delivery is desirable. Continuous delivery refers to the ability to get changes of all types -- including new features, configuration changes, bug fixes, and experiments -- into production, and in front of customers safely and quickly in a sustainable way. GitOps is an approach to continuous delivery that relies on using a source control system as a single source of truth for all infrastructure and configuration. In the GitOps model, configuration changes go through a specific workflow such as follows:
1. All configuration is stored in source control.
2. A configuration change is made via pull request.
3. The pull request is approved and merged into the production branch.
4. Automated systems (e.g., a continuous integration pipeline) ensure the configuration of the production branch is in full sync with actual production systems.

It will be appreciated that individual users should never directly apply configuration changes to a live production cluster. Instead, any changes happen via the source control system. This entire workflow is also self-service in the sense that an operations team does not need to be directly involved in managing the change process, except in the review/approval process, if desirable.

The source control approach is in contrast to a traditional, manual workflow, which can take place as follows:
1. App developer defines configuration.
2. App developer opens a ticket for operations.
3. Operations team reviews ticket.
4. Operations team initiates infrastructure change management process.
5. Operations team executes change using UI or REST API.
6. Operations team notifies app developer of the change.
7. App developer tests change and opens a ticket to give feedback to operations if necessary.

The self-service, continuous delivery model according to the present disclosure is critical for ensuring that operations can scale. Adopting a continuous delivery workflow according to the present disclosure provides several advantages. One advantage is that of reduced deployment risk. By immediately deploying approved configuration into production, configuration issues can be rapidly identified. Resolving any issue can encompass rolling back the change in source control, for example. Another advantage is auditability, where understanding the specific configuration is as simple as reviewing the configuration in the source control repository. Moreover, any changes made to the configuration can also be recorded, providing context on previous configurations. A further advantage is the provision of simpler infrastructure upgrades. Upgrading any infrastructure component, whether the component is Kubernetes™ or some other piece of infrastructure, is straightforward. A replica environment can be easily created and tested directly from the source control system. Once the upgrade has been validated, the replica environment can be swapped into production, or production can be live upgraded. A further advantage is security, as access to production cluster(s) can be restricted to senior operators and an automated system, reducing the number of individuals who can directly modify the cluster.

The advantages of the GitOps approach have driven rapid adoption across the Kubernetes™ ecosystem. At the same time, GitOps is not a panacea. One of the biggest challenges in adopting GitOps is getting feedback on configuration changes before they are rolled into production. A typical process with GitOps is to deploy changes into a test environment, and then, assuming no issues, to deploy the exact changes into production. The challenge is that test environments are poor facsimiles of production, and many outages occur because of this difference. Moreover, humans can and do make mistakes, and do not thoroughly test changes before they are deployed.

Embodiments of the system and method according to the present disclosure facilitate solutions to this problem whereby:
1. Real-time status information from the target environment is obtained and compared with the intended configuration change that is in source control.
2. The difference between the future configuration and actual configuration is determined.
3. The difference is then analyzed to determine its impact.
4. The results of this analysis can be posted as a comment in the user’s GitOps workflow.
5. The user is then able to read the analysis to determine whether or not it is appropriate to apply the change into production.

This approach gives immediate analysis of any intended changes to the end user as part of his or her existing workflow.

It will be appreciated that adopting a GitOps workflow according to traditional practices requires an extensive amount of engineering. Further, traditional models for providing feedback to the user are through graphical user interfaces (e.g., administration consoles) and/or command line interfaces.

With the Developer Control Plane according to the present disclosure, one can quickly and easily adopt a GitOps workflow without any custom engineering. Further, embodiments of the present disclosure support automatic analysis and resolution of configuration changes that are made via a pull request before a change goes live. According to embodiments as described herein, feedback can be provided directly to the user as a comment in their source control system and as part of the source control workflow, so there is no separate system to run. Further, the feedback and analysis that are run are presented prior to the changes going live, so configuration issues can be detected before they go live. Past dry run interfaces are not integrated into the source control workflow such as disclosed herein. It will be appreciated that the advanced forms of analysis such as described herein are performed by layering the system’s understanding of prior configuration, runtime information, and other data to provide a sophisticated analysis of what is occurring. In these ways, negative events in production can be anticipated and prevented from occurring.

In exemplary arrangements, the present disclosure provides a system facilitating the receiving of a proposed configuration change event from a source code manager, dispatching the proposed configuration change event to a program running in a remote server or cluster, retrieving a real-time server or cluster configuration, determining the effect of a requested change associated with the proposed configuration change event on the remote server or cluster, and reporting an impact of the requested change in the source code manager.

### BRIEF DESCRIPTION OF THE DRAWINGS

FIG. 1 is a schematic diagram of an embodiment of the present disclosure.

FIG. 2 is an exemplary process diagram illustrating processing of a proposed configuration change event accordance with embodiments of the present disclosure.

### DETAILED DESCRIPTION OF EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or more than one of the described element. Thus, for example, reference to a processor may encompass one or more processors, a server may encompass one or more servers, and so forth.

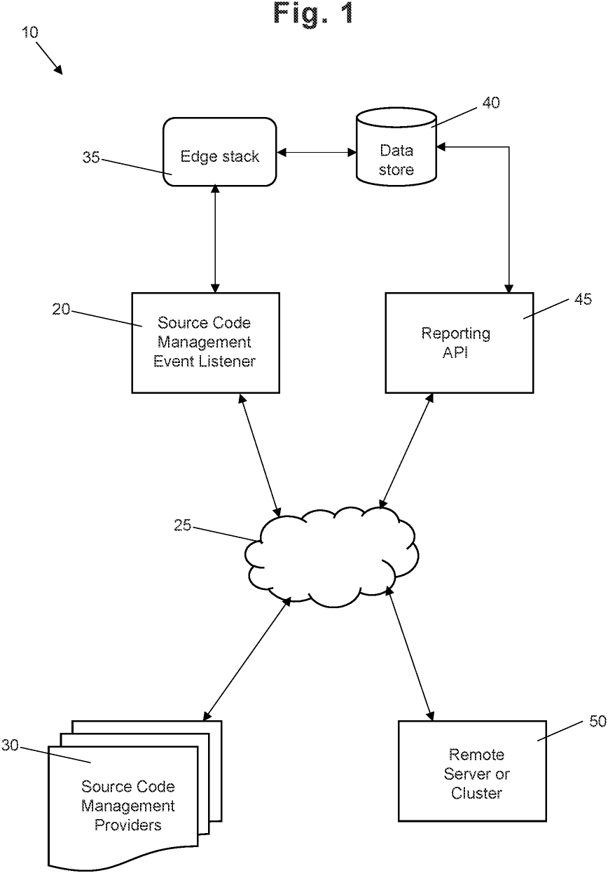

As shown in FIG. 1, embodiments of the present disclosure provide a system 10 for real-time configuration analysis whereby a source code management event listener 20 is in communication over a network 25 with one or more source code managers 30. The source code managers 30 can include, for example, GitHub, GitLab and/or Bitbucket or other version control systems based on Git, for example. The network 25 can be a data network such as a local area network (LAN), a wide area network (WAN), a public network such as the Internet, or a private network. The source code management event listener 20 and other elements disclosed herein are configured to connect to the network 25 in any suitable manner such as via a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium.

As further shown in FIG. 1, the source code management event listener 20 is in communication with an edge stack 35 which can facilitate communications with a database or data store 40, a reporting application programming interface (API) 45 and a remote server or cluster 50. For purposes of the present disclosure, element 50 will be referred to as a remote server but it will be appreciated that the remote server can include one or more servers and can be aggregated as a cluster. The remote server 50 can communicate with the data store 40 via reporting API (45) and via network 25, for example. It will be appreciated that the source code manager(s) 30, the source code management event listener 20 and the edge stack 35 are part of a pull request pipeline, whereas the reporting API 45 and remote server 50 are part of a reporting pipeline in accordance with the present disclosure. In various embodiments, the data store 40 is shared by the pull request pipeline and the reporting pipeline, and the reporting pipeline can be embodied as a Kubernetes™ cluster.

It will further be appreciated that the source code management event listener 20 and the remote server 50, respectively, can be any suitable computing device that includes at least one processor and at least one memory device or data storage device. The computing device can be configured to transmit and receive data or signals representing events, messages, commands, or any other suitable information in accordance with the present disclosure. The computing device can further be configured to execute the events, messages, or commands represented by such data or signals in accordance with the present disclosure.

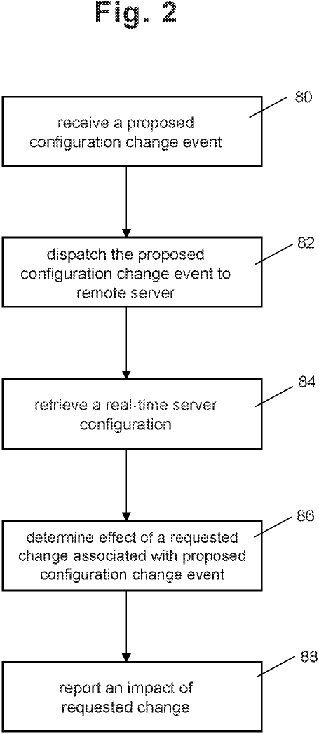

FIG. 2 illustrates an exemplary process as may be carried out by elements of the system shown in FIG. 1 according to embodiments of the present disclosure. As at 80, a proposed configuration change event can be received. This proposed configuration change event can be received by the source code management event listener 20 from a source code manager 30. As at 82, the proposed configuration change event can be processed and dispatched by the source code management event listener to the edge stack 35 and/or the remote server 50. As at 84, programming operable via the remote server 50 retrieves a real-time server configuration. The real-time server configuration can be retrieved from the source code manager 30, for example. As at 86, the effect of a requested change associated with the proposed configuration change event on the remote server is determined. In various embodiments, this effect is determined via programming operable via the remote server 50. As at 88, the system reports an impact of the requested change in the source code manager 30. This reporting can be performed via remote server 50 communicating via network 25.

As an example, the impact may be a warning about a conflict or invalid configuration. The reporting can be effectuated in real-time and can be presented as a comment in a user’s interface associated with the source code manager 30, for example. In this way, the reporting is made before any requested change can go live. In the event the requested change is deemed problematic, the user is made aware and can re-evaluate the situation. If the requested change is deemed acceptable or appropriate, the user can initiate an instruction to apply the requested change into production, and the system can receive the instruction and effectuate the requested change. In various embodiments, the system and method disclosed herein assist in resolving problems as they are reported. The system and method can further obtain real-time status information from a target environment such as a production cluster and compare the real-time status information with the requested change.

It will thus be appreciated that the presently disclosed system and method combines source control, real-time analysis and posting in real-time to a user’s workflow to provide a technical solution to problems associated with past efforts such as producing error codes via a REST API or producing an error message via a graphical user interface. The immediate feedback loop provided by the presently disclosed system and method thereby reduces deployment risk while providing for auditability, security and enhanced infrastructure upgrades. By layering the system’s understanding of prior configuration, runtime information, and other data, embodiments of the system and method herein can provide a sophisticated analysis of what is occurring to the user.

The embodiments of the present disclosure can be implemented using one or more conventional general purpose or specialized digital computers, computing devices, machines, or microprocessors, including one or more processors, memory and/or computer readable storage media programmed according to the teachings of the present disclosure. Appropriate software code can be prepared by skilled programmers using the teachings of the present disclosure.

In various embodiments, the components and elements described herein can be implemented as software and/or hardware on a computing platform, such as a network server or computer or a computing environment including multiple computing elements.

The present disclosure contemplates a variety of different systems each having one or more of a plurality of different features, attributes, or characteristics. A “system” as used herein refers to various configurations of: (a) one or more configuration analysis systems; and (b) one or more computing devices, such as remote server 50, a desktop computer, a laptop computer, a tablet computer, a personal digital assistant, a mobile phone, and other mobile computing devices. Many of the tasks, such as evaluating configuration changes may be performed with a computing device such as remote server 50.

It will be appreciated that any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing, including a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

It will be appreciated that all of the disclosed methods and procedures herein can be implemented using one or more computer programs or components. These components may be provided as a series of computer instructions on any conventional computer-readable medium, including RAM, SATA DOM, or other storage media. The instructions may be configured to be executed by one or more processors which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user’s computer, partly on a user’s computer, as a stand-alone software package, partly on a user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

1. A system for real-time configuration analysis, comprising:
a processor, and a memory storing instructions that, when executed by the processor, cause the processor to:
receive a proposed configuration change event from a source code manager;
dispatch the proposed configuration change event to the remote server;
retrieve a real-time server configuration;
determine the effect of a requested change associated with the proposed
configuration change event on the remote server; and
report the impact of the requested change in the source code manager.

2. The system of claim 1, wherein the reported impact is a warning pertaining to a conflict.

3. The system of claim 1, wherein the reported impact is a warning pertaining to an invalid configuration.

4. The system of claim 1, wherein the reported impact is issued in real-time.

5. The system of claim 1, wherein the reported impact is a comment in a system user interface associated with the source code manager.

6. The system of claim 5, wherein the instructions further cause the processor to receive an instruction to apply the requested change into production.

7. The system of claim 1, wherein the reported impact is made before the requested change can go live.

8. The system of claim 1, wherein the data store is shared by a pull request pipeline and a reporting pipeline, and wherein the reporting pipeline comprises a Kubemetes cluster.

9. The system of claim 1, wherein the instructions further cause the processor to obtain real-time status information from a target environment and compare the real-time status information with the requested change.

10. The system of claim 1, wherein the real-time server configuration is retrieved from the source code manager.

11. A computer-implemented method, comprising:
receiving, by a source code management event listener, a proposed configuration change event from a source code manager;
dispatching, by the source code management event listener, the proposed configuration change event to a remote server;
retrieving a real-time server configuration;
determining, via the remote server, the effect of a requested change associated with the proposed configuration change event on the remote server; and
reporting, via the remote server, an impact of the requested change in the source code manager.

12. The method of claim 11, wherein the reported impact is a warning pertaining to a conflict.

13. The method of claim 11, wherein the reported impact is a warning pertaining to an invalid configuration.

14. The method of claim 11, wherein the reported impact is issued in real-time.

15. The method of claim 11, wherein the reported impact is a comment in a system user interface associated with the source code manager.

16. The method of claim 15, wherein the instructions further cause the processor to receive an instruction to apply the requested change into production.

17. The method of claim 11, wherein the reported impact is made before the requested change can go live.

18. The method of claim 11, wherein the data store is shared by a pull request pipeline and a reporting pipeline, and wherein the reporting pipeline comprises a Kubemetes cluster.

19. The method of claim 11, wherein the instructions further cause the processor to obtain real-time status information from a target environment and compare the real-time status information with the requested change.

20. The method of claim 11, wherein the real-time server configuration is retrieved from the source code manager.
